(19) United States
(12) Patent Application Publication
(10) Pub. No.: US 2005/0017561 A1
(43) Pub. Date: Jan. 27, 2005

(54) Seat, seat recliner mechanism, and seat recliner system

(76) Inventors: Richard F. Burmeister III, Grand Rapids, MI (US); David C. Savage, Kentwood, MI (US)

Correspondence Address: Warner Norcross & Judd LLP, 900 Fifth Third Center, 111 Lyon Street, N.W., Grand Rapids, MI, 49503-2487, US

(21) Appl. No.: 10/623,701

(22) Filed: Jul. 21, 2003

(51) Int. Cl. B60N 2/22

(52) U.S. Cl. 297/354.12; 297/362; 297/374

(57) ABSTRACT

The seat back of a seat is attached to a seat recliner mechanism. As the seat back is moved, it moves in a curvilinear motion centered about or near the seat H-Point. The seat recliner mechanism, attached to the seat back, has arcuate slots. The center of the curves of these arcuate slots are located at or near the seat H-Point. A seat recliner system has two seat recliner mechanisms operating in tandem.

### BACKGROUND OF THE INVENTION

Modern seats have many specially designed support areas for the comfort and safety of the passenger. For example, seats often have specially designed neck, shoulder and lumbar supports, as well as vertical and horizontal stabilizing supports. These supports are generally arranged to properly align with the passenger's body when the seat is in the upright position. The supports are often positioned relative to the “H-Point” of a seat.

“H-Point” refers to the hip pivot point of a hypothetical passenger. As is well-known, the most common method for determining the H-Point of a seat is to use an H-Point dummy. The procedure for determining the H-Point can be found in Society of Automotive Engineers (SAE) document J826.

Seat occupants often desire to change the position of the seat back. In automobile seats, the seat back is often attached at a single pivot point near the bottom of the seat back. The passenger then rotates the seat back either forward or backward.

The pivot point of the seat back, however, is located near the bottom of the seat back. Because the seat H-Point is not located near the bottom of the seat back, the relative position of the seat back to the back of the passenger changes. For example, if the seat back is moved backwards to a more reclining position, the passenger's back slides down the seat back. This causes the seat's support and safety components to move out of alignment with the occupants back, creating discomfort for the passenger and increasing the risk to the passenger in case of a collision. This may also cause the shirt of the passenger to gather, again resulting in an increase of discomfort to the passenger.

### SUMMARY OF THE INVENTION

The problems described above are overcome by providing a seat with a seat back which rotates about the seat's H-Point rather than a pivot point at the bottom of the seat back.

The rotation of the seat about the H-Point is accomplished by a recliner mechanism. The recliner mechanism has an arcuate slot. The curve of the arcuate slot's center is located near or at the seat's H-Point. A seat back holder, integral with the seat back, moveably resides within the arcuate slot. The seat back thus moves along a curve which is also centered at the seat's H-Point.

Additionally, a seat recliner system has two recliner mechanisms operating in tandem. Both seat recliner systems have arcuate slots. The centers of the curve of the arcuate slots are aligned along an axis of rotation for the seat back. The axis of rotation for the seat back includes the seat's H-Point.

Rotation of the seat back about the H-Point increases the seat's comfort. The seat back's position relative to the occupant's back remains constant. Thus, the seat's supports and safety features remain properly aligned with the occupant, thereby reducing the chance of injury. Other problems, such as shirt gathering, are reduced. The seat is thus more comfortable, ergonomic and safer.

These and other objects, advantages and features of the invention will be more readily understood and appreciated by reference to the detailed description of the drawings.

### BRIEF DESCRIPTION OF THE DRAWINGS

FIG. 1 is a side elevation of a seat utilizing the recliner mechanism with the seat in the upright position.

FIG. 2 is a side elevation of a seat utilizing the recliner mechanism, with the in the seat reclining position.

FIG. 3 is a perspective view of the recliner mechanism of FIG. 1.

FIG. 4 is a perspective view of a seat recliner system utilizing the recliner mechanism of FIG. 3.

FIG. 5 is a side view of a seat recliner mechanism.

FIG. 6 is a perspective view of a seat recliner mechanism.

### DETAILED DESCRIPTION OF THE DRAWINGS

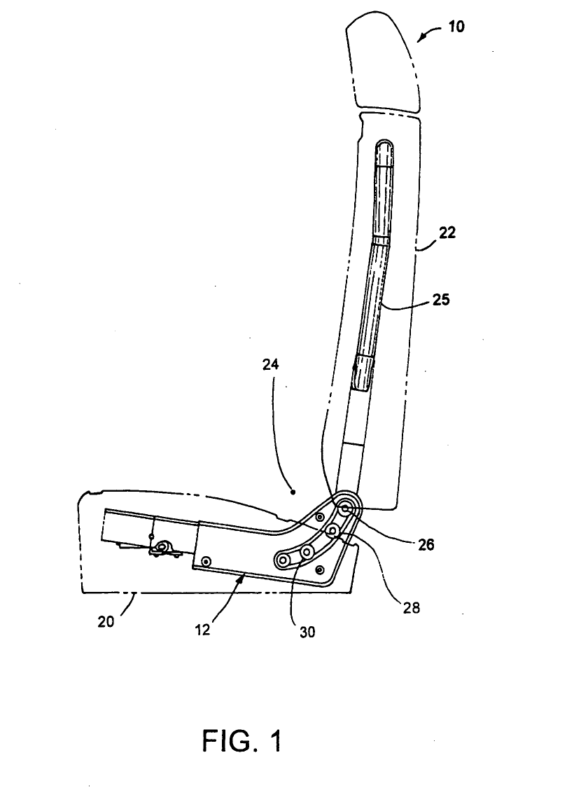

FIG. 1 shows a seat 10 using the recliner mechanism 12 in the upright position. The seat 10 is composed of seat pan 20 and seat back 22. The seat has an H-Point 24. Seat frame bar 25 extends through seat back 22. Seat holders 26, 28 are attached near the bottom of seat frame bar 25. Seat holders 26, 28 rest within arcuate slot 30. Seat holders 26, 28 are shown as plurality of wheels slideable within arcuate slot 30. Alternatively, seat holders 26, 28 could be gears, pins, or other devices which allow movement within arcuate slot 30.

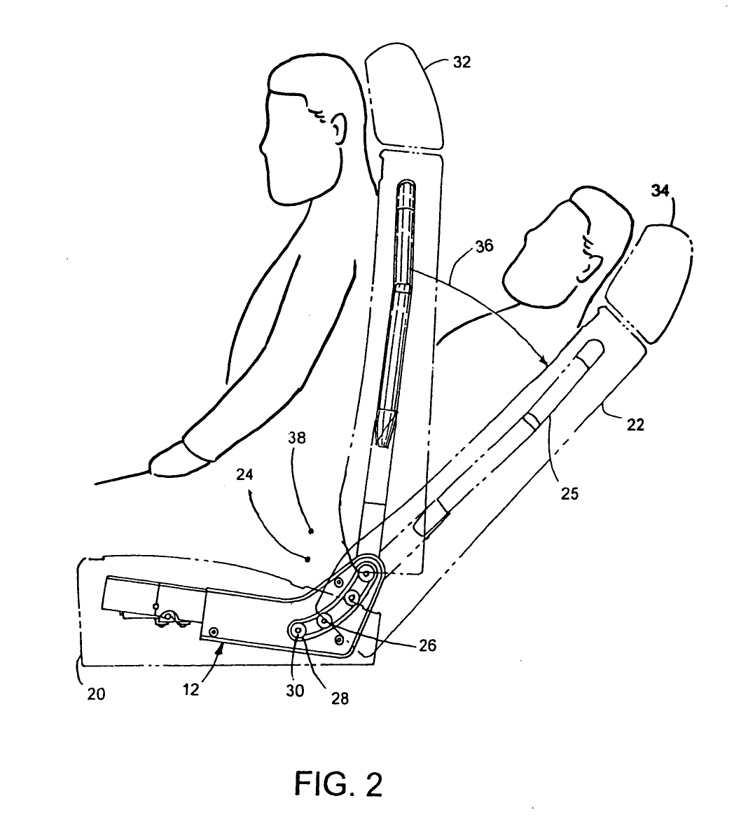

FIG. 2 shows the same seat 10 using the recliner mechanism 12, but the seat 10 is shown in upright position 32 and reclined position 34. The seat back 22 moves from upright position 32 to reclined position 34 along a seat back curve 36. The seat back curve center 38 is the center of the seat back curve 36.

As is shown the seat back curve center 38 and the seat H-Point 24 are very close. The seat back curve center 38 and the seat H-Point 24 could be coincident. Alternatively, it might be preferable to position the seat back curve center 38 close to, but not coincident with the seat H-Point 24. For example, the seat back curve center 38 could be within three inches of the seat H-Point 24.

The seat H-point 24 is determined with reference to an H-Point dummy sitting in an upright position. However, at some position, for example, if the seat 10 were fully reclined, it might be preferable to have the support and safety components of the seat 10 aligned differently. This could be easily done with the recliner mechanism 12 by providing arcuate slot 30 with a compound arc such that there are two or more different centers. In that case, arcuate slot 30 would have a first arcuate slot curve portion and a second arcuate slot curve portion. The first arcuate slot curve portion would have a first arcuate slot curve portion center and the second arcuate slot curve portion would have a second arcuate slot curve portion center. The first arcuate slot curve portion center the seat H-Point 24 while the second arcuate slot curve portion center near another point.

Because the seat curve center 38 is very near or coincident with the seat H-Point 24, the motion of the seat back 22 relative to the back of the passenger is minimized. Thus, various features of the seat, such as the support and safety elements of the seat, remains at or near the optimum position relative to an occupant's back. Similarly, problems such as “shirt gathering” are reduced. The seat 10 is thus more comfortable, ergonomic and safer than previous seats.

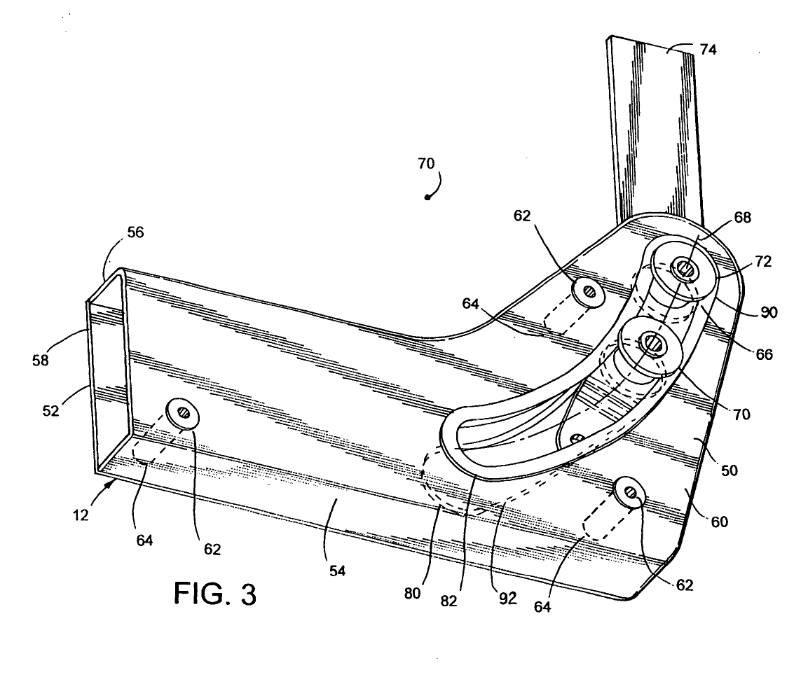

FIG. 3 is a perspective view of the recliner mechanism 12. Recliner mechanism has an outer recliner mechanism side 50, an inner recliner mechanism side 52, a recliner mechanism bottom 54, a recliner mechanism top 56, a recliner mechanism front 58, and a recliner mechanism back 60.

Three outer recliner mechanism side mounting holes 62 are disposed on the outer recliner mechanism side 50. Similarly, three inner recliner mechanism side mounting holes 64 are on the inner recliner mechanism side 52. The inner recliner mechanism side mounting holes 64 and the outer recliner mechanism side mounting holes 62 are aligned so that a bolt, screw or other holder device may easily extend through the inner recliner mechanism side 52 and the outer recliner mechanism side 50 and securely fasten the recliner mechanism 12 to an automobile.

Outer recliner mechanism side arcuate slot 66 is located near recliner mechanism back 60. Outer recliner mechanism side arcuate slot 66 has an outer recliner mechanism side arcuate slot curve 68. The outer recliner mechanism side arcuate slot curve 68 has an outer recliner mechanism side arcuate slot curve center 70 at some point distant from the outer recliner mechanism side arcuate slot 66. The outer recliner mechanism side arcuate slot curve center 70 is located above the recliner mechanism top 56 and between the recliner mechanism front 58 and the recliner mechanism back 60.

The outer recliner mechanism side arcuate slot 66 is arranged so that seat holders 70, 72 can rest within the outer recliner mechanism side arcuate slot 66. The seat holders 70, 72 are attached to the seat frame bar 74. While the seat holders 70, 72 are shown as a plurality of wheels in FIG. 3, there are many other devices which could work as well, such as pins or gears.

As the seat holders 70, 72 are moved upward or downward within the outer recliner mechanism side arcuate slot 66, the seat frame bar 74 rotates forward or back. Importantly, the motion of the seat frame bar 74 is that of rotation about at some point generally in front of the seat frame bar 74 and above the recliner mechanism top 56 rather than pivoting about a point near the bottom of the seat frame bar 74. The seat frame bar 74 extends into the seat back 22, shown in FIG. 1 and FIG. 2.

Through careful selection of the configuration of the outer recliner mechanism side arcuate slot curve 68, the rotation point for the seat frame bar 74, and thus of the seat back 22 can be selected to coincide with the H-Point of the seat 10. Thus, the comfort and ergonomic safety of the seat 10 is improved. By providing a more comfortable seat, the fatigue of the seat occupant is decreased. If the seat 10 is used in an automobile for the driver, the seat 10 will increase the alertness of the driver, thereby increasing the driving safety of now only the other vehicle passengers, but the passengers of other vehicles.

FIG. 3 shows that the inner recliner mechanism side 52 similarly has an inner recliner mechanism side arcuate slot 80. The inner side arcuate slot 80 has an inner side arcuate slot curve 82. The inner side arcuate slot 80 is disposed so as to receive the seat holders 70, 72. Inner side arcuate slot curve 82 has an inner side arcuate slot curve center 84. The operation of the seat frame bar 74 relative to the inner side arcuate slot 80 is similar to that of the operation of the seat frame bar 74 relative to the outer recliner mechanism side arcuate slot 66.

Seat holders 70, 72 would preferably be nylon bearings. Use of nylon bearings result in reduced sound level and produces a smooth feel during movement of the seat back. Additionally, the nylon bearing reduce the chuck of the seat and allows some tolerance to the variation in the sizes of the seat holders 70, 72 and the arcuate slots.

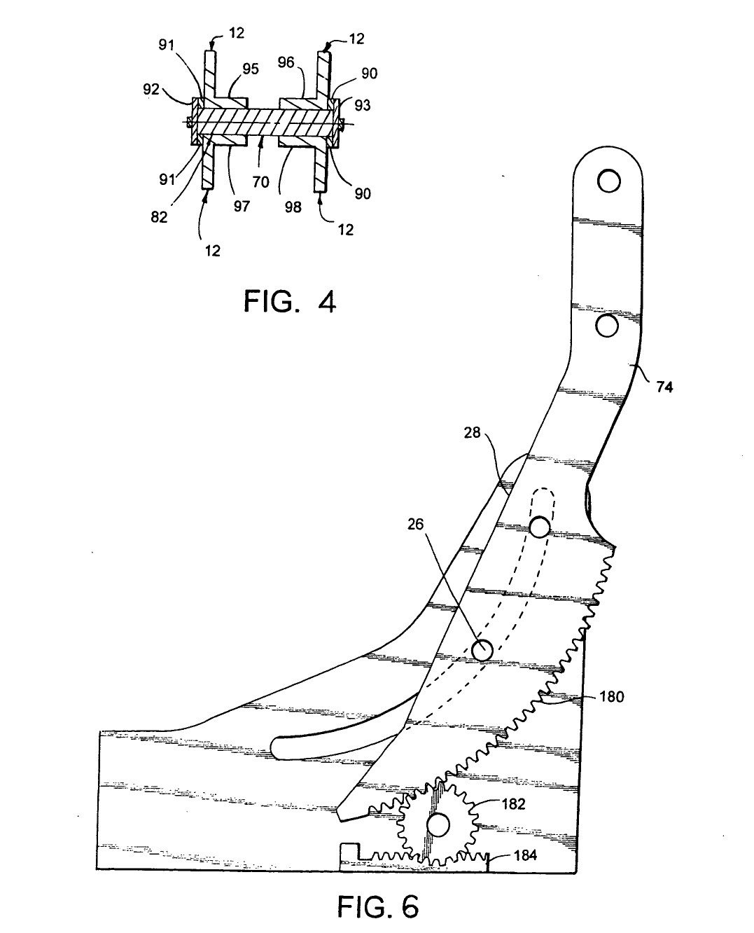

FIG. 4 shows a perspective view of a seat recliner system 100. The seat recliner system 100 is composed of a first recliner mechanism 102 and a second recliner mechanism 104. A recliner drive assembly 106 is attached to the first recliner mechanism 102 and the second recliner mechanism 104.

The first recliner mechanism 102 has a first recliner mechanism outer arcuate slot 110. Similar to FIG. 1, the first recliner mechanism outer arcuate slot 110 has a first recliner mechanism outer arcuate slot curve 112. The first recliner mechanism inner arcuate slot 114 has a the first recliner mechanism inner arcuate slot curve 116. First recliner mechanism 102 has a first recliner mechanism top 118, a first recliner mechanism front 120, and a first recliner mechanism back 122.

The first outer seat holders 124, 126 moveably reside within the first recliner mechanism outer arcuate slot 110. The first outer seat holders 124, 126 are fixedly attached to the seat frame bar 128 at the first seat frame bar leg 130.

The first recliner mechanism 102 likewise has a first recliner mechanism inner arcuate slot 132 and a first recliner mechanism inner arcuate slot curve 134. The first inner seat holders 136, 138 moveable reside within the first recliner mechanism inner arcuate slot 132. The first inner seat holders 136, 138 are fixedly attached to the seat back frame bar 128 at the first seat back frame bar leg 130.

The second recliner mechanism 104 has a second recliner mechanism inner arcuate slot 140. The second recliner mechanism outer arcuate slot 140 has a second recliner mechanism outer arcuate slot curve 142. The second recliner mechanism outer arcuate slot 144 has a second recliner mechanism inner arcuate slot curve 146. The second recliner mechanism 104 has a second recliner mechanism top 148, a second recliner mechanism front 150, and a second recliner mechanism back 152.

The second inner seat holders 154, 156 moveably reside within the second recliner mechanism inner arcuate slot 140. The second inner seat holders 154, 156 are fixedly attached to the seat back frame bar 128 by way of the second frame leg 158. Similarly, the second outer seat holders 160, 162 moveably reside within the second recliner mechanism outer arcuate slot 164. The second outer seat holders 160, 162 likewise fixedly attached to the seat back frame bar 128 by way of second frame leg 158.

As stated previously, the seat holders 124, 126, 136, 138, 154, 156, 160, 162 are shown as a plurality of wheels, but the seat holders 124, 126, 136, 138, 154, 156, 160, 162 could be any number of different holders, such as pins or gears.

Generally, the first recliner mechanism inner arcuate slot curve 134, the first recliner mechanism outer arcuate slot curve 138, second recliner mechanism outer arcuate slot curve 154, and second recliner mechanism inner arcuate slot curve 158 have the same curvature. Thus, the curve center for each of the arcuate slot curves 134, 138, 154, 158 define a line segment 170.

The line segment 170 is located above the first recliner mechanism top 118 and the second recliner mechanism top 148. The line segment is also located between the first recliner mechanism front 120 and the first recliner mechanism back 122.

In addition to being parallel to the first and second recliner mechanism tops 118, 148, the line segment preferably would also contain the seat H-Point 172.

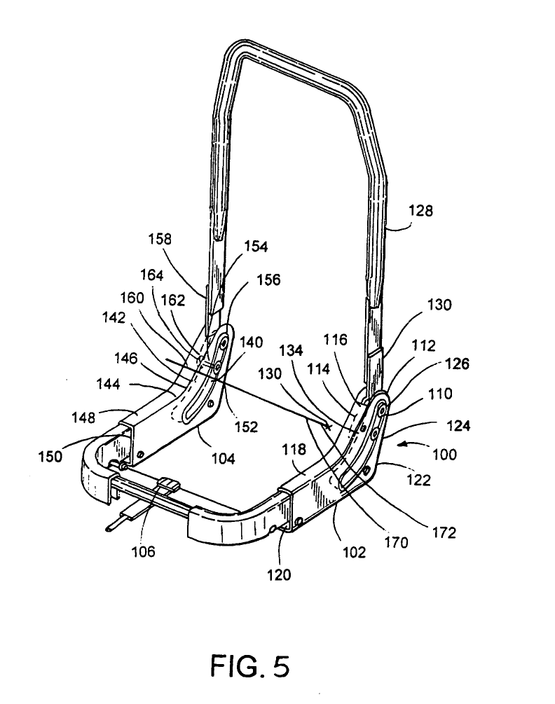

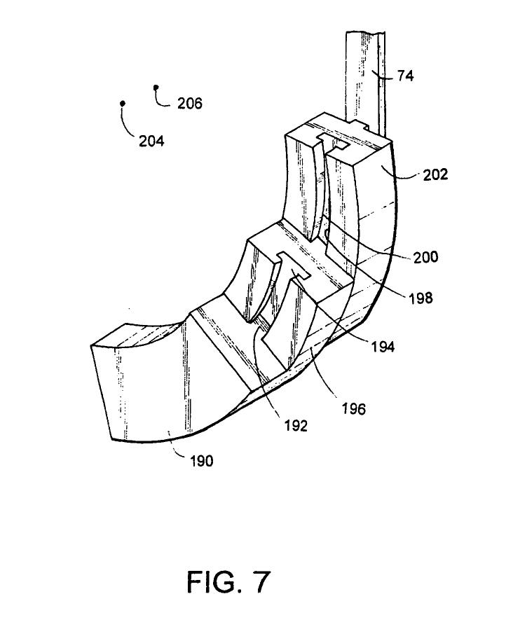

FIG. 5 shows a different embodiment of a recliner mechanism. Seat bar 74 includes curved rack 180. Pinion 182 meshes with both curved rack 180 and linear rack 184. As pinion 182 pivots, seat holders 26, 28 move within arcuate slot 30. Pinion 182 could be manipulated by a hand crank or by an electric motor.

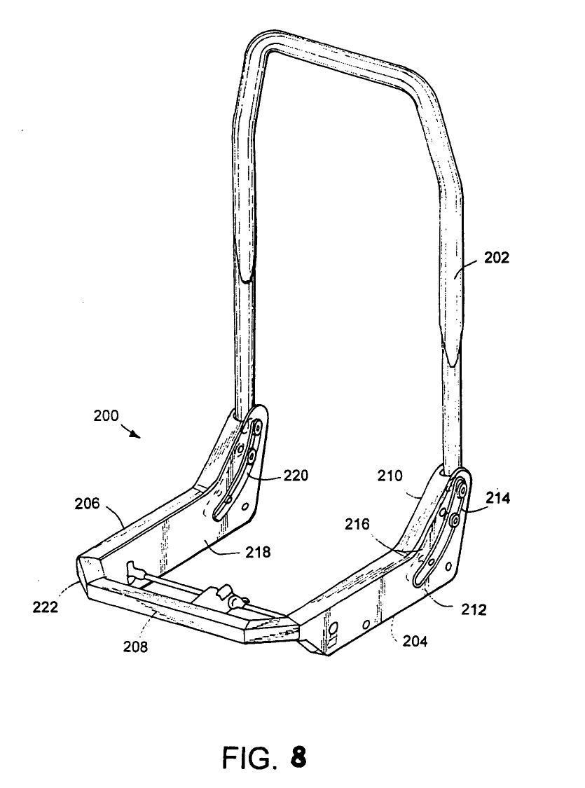

FIG. 6 shows another embodiment of a recliner mechanism allowing a seatback to rotate about the seat's H-point. Base 190 may be affixed to the floor of a motor vehicle. Base 190 is generally curved with a rectangular cross section. On one side is base wing 192. Base wing 192 extends axially from base 192, and is slideably engaged within first slot 194 of first curved bracket 196. Base wing 192 extends the length of base 192. Bracket 196 moves on a curvilinear path prescribed by the base wing 192. Bracket wing 198 extends axially from first curved bracket 196 and is slideably engaged within second slot 200 of second curved bracket 202. Seat bar 74 is attached to the top of second curved bracket 202.

The operation of the recliner mechanism shown in FIG. 6 is best understood if it is assumed that first curved 196 and second curved bracket 202 are fully extended. As second bracket 202 is retracted, second bracket 202 bracket wing 198 guides second bracket 202 on a curved path. Seat bar 74 thus follows a curved path, and a seat back attached to seat bar 74 will likewise follow a curved path. The curved path will have a second bracket center 202. When second bracket 202 has been completely retracted, then first bracket 196 will begin to retract along the path of base wing 192. Seat bar 74 will likewise follow the curved path prescribed by the curvature of base wing 192. The center of this curve path will be located at the base center 204. As it retracts, seat bar 74 could follow two curved paths with each curve having a different center. Either of the two centers of the curved path could be the seat's H-point. Alternatively, one center could be the seat's H-point in a first position, while the second seat could be the seat's H-point in a second position.

The above description is of the preferred embodiment. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a,” “an,” “the,” or “said,” is not to be construed as limiting the element to the singular.

1. A recliner mechanism for a seat, the seat having a seat back and a seat pan, the recliner mechanism having a recliner mechanism top, a recliner mechanism back, a recliner mechanism front and a recliner mechanism back, comprising:
a recliner mechanism side having a recliner mechanism side arcuate slot;
the recliner mechanism side arcuate slot disposed to receive a seat holder;
the recliner mechanism side arcuate slot having a recliner mechanism side arcuate slot curve;
the recliner mechanism side arcuate slot curve having a recliner mechanism side arcuate slot curve center; and
where the recliner mechanism side arcuate slot curve center is disposed above the recliner mechanism top and between the recliner mechanism front and the recliner mechanism back.

2. The recliner mechanism of claim 1 where the seat has a seat H-Point, and the recliner mechanism side arcuate slot curve center is coincident with the seat H-Point.

3. The recliner mechanism of claim 1 where the seat has a seat H-Point, and the recliner mechanism side arcuate slot curve center is near the seat H-Point.

4. The recliner mechanism of claim 1 where the seat has a seat H-Point, and the recliner mechanism side arcuate slot curve center is within about three inches of the seat H-Point.

5. The recliner mechanism of claim 1 where the seat has an H-Point, and the arcuate slot curve has a first arcuate slot curve portion and a second arcuate slot curve portion, where the first arcuate slot curve portion has a first arcuate slot curve portion center and the second slot curve portion has a second arcuate slot curve portion center, and the first arcuate slot curve portion center is not coincident with the second slot curve portion center.

6. The recliner mechanism of claim 5 where the first slot curve portion center is near the seat H-Point.

7. The recliner mechanism of claim 5 where the first slot curve portion center is coincident with the seat H-Point.

8. A recliner mechanism for a seat, the seat having a seat back and a seat pan, the recliner mechanism having a recliner mechanism top, a recliner mechanism back, a recliner mechanism front and a recliner mechanism back, comprising:
a first recliner mechanism side having a first recliner mechanism side arcuate slot, the first recliner mechanism disposed to receive a first seat holder;
a second recliner mechanism side having a second recliner mechanism side arcuate slot disposed to receive a second seat holder;
the first recliner mechanism side arcuate slot having a first arcuate slot curve, the first arcuate slot curve having a first arcuate slot curve center, the first arcuate slot curve center being disposed above the recliner mechanism top and between the recliner mechanism back and the recliner mechanism front;
the second recliner mechanism side arcuate slot having a second arcuate slot curve, the second arcuate slot curve having a second arcuate slot curve center, the second arcuate slot curve center being disposed above the recliner mechanism top and between the recliner mechanism back and the recliner mechanism front;
the first arcuate slot curve center and the second arcuate slot curve center forming a line segment; and
the line segment being parallel to the recliner mechanism top.

9. The recliner mechanism of claim 8 where the seat has an H-Point, and the line segment includes the seat H-Point.

10. The recliner mechanism of claim 9 where the line segment is within 3 inches of the seat H-Point.

11. The recliner mechanism of claim 9 where the first seat holder and the second seat holder are attached to the seat back.

12. The recliner mechanism of claim 9 where the first seat holder is attached to the seat back, and the second seat holder is attached to the seat back, and the first seat holder is moveable within the first recliner mechanism side arcuate slot and the second seat holder is moveable within the second recliner mechanism side arcuate slot, such that the seat back moves in a seat back curve, where the seat back curve has a seat back curve center, and the seat back curve center is located above the seat pan.

13. The recliner mechanism of claim 12 where the seat back curve center is coincident with the seat H-Point.

14. The recliner mechanism of claim 13 where the seat back curve center is near the seat H-Point.

15. The recliner mechanism of claim 14 where the seat back curve center is within 3 inches of the seat H-Point.

16. A seat, the seat having a seat H-Point, comprising:
a seat pan; and
a seat back, the seat back moveable relative to the seat pan along a seat back curve, the seat back curve having a seat back curve center, where the seat back curve center is near the seat H-Point.

17. The automobile seat of claim 16 where the seat back curve center is coincident with the seat H-Point.

18. The automobile seat of claim 17 where the seat back curve center is within about three inches of the seat H-Point.

19. The automobile seat of claim 18 where the seat back has a seat back frame, the seat back frame moveably attached to a first recliner mechanism.

20. The automobile seat of claim 19 where the seat back frame is moveably attached to a first recliner mechanism by a seat holder.

21. The automobile seat of claim 16 where the seat back frame has a first leg and a second leg, the first leg moveably attached to a first recliner mechanism and the second leg moveably attached to a second recliner mechanism.

22. The automobile seat of claim 21 where the first leg is moveably attached to the first recliner mechanism by a first seat holder and the second leg is moveably attached to the second recliner mechanism by a second seat holder.

23. The automobile seat of claim 22 where the first seat holder is comprised of a first plurality of wheels and the second seat holder is comprised of a second plurality of wheels.

24. The automobile seat of claim 22 where the first leg has a first curved rack proximal to the first seat holder and arranged to receive a first pinion.

25. The automobile seat of claim 24 where the first recliner mechanism has a first linear rack located below and spaced from the first curved rack and arranged to receive the first pinion.

26. The automobile seat of claim 25 where the second leg has a second curved rack proximal to the second seat holder and arranged to receive a second pinion.

27. The automobile seat of claim 25 where the second recliner mechanism has a second linear rack located below and spaced from the second curved rack and arrange to receive the second pinion.

28. The automobile seat of claim 21 where the recliner mechanism comprises:
a first arcuate member having a first arcuate member slot moveably holding a portion of the first leg;
a first arcuate member slot curve; and
the first arcuate member slot curve having a first arcuate member slot curve center, the first arcuate slot curve center located near the seat H-Point.

29. The automobile seat of claim 21 where the recliner mechanism comprises;
a first arcuate member having a first arcuate member slot moveably holding a portion of the first leg, the first arcuate slot member having a first arcuate member slot curve and the first arcuate member slot curve having a first arcuate member slot curve center, the first arcuate slot curve center located near the seat H-Point; and
a second arcuate member having a second arcuate member slot moveably holding a portion of the second leg, the second arcuate slot member having a second arcuate member slot curve and the second arcuate member slot curve having a second arcuate member slot curve center, the second arcuate slot curve center located at some point other than the H-Point.

30. A seat recliner system for a seat, the seat having a seat H-Point, the seat having a seat back and a seat pan, comprising:
a first recliner mechanism moveably attached to the seat back by a first seat holder, the first recliner mechanism having a first recliner mechanism arcuate slot, the first recliner mechanism arcuate slot having a first recliner mechanism arcuate slot curve, the first recliner mechanism arcuate slot curve having a first recliner mechanism arcuate slot curve center;
a second recliner mechanism moveably attached to the seat back by a second seat back holder, the second recliner mechanism having a second recliner mechanism arcuate slot, the second recliner mechanism arcuate slot having a second recliner mechanism arcuate slot curve, the second recliner mechanism arcuate slot curve having a second recliner mechanism arcuate slot curve center; and
the first recliner mechanism arcuate slot curve center and the second recliner mechanism arcuate slot curve center defining a line segment, whereby the line segment is located near the seat H-Point.

31. The seat recliner system of claim 30 where the seat H-Point lies on the line segment.

32. The seat recliner system of claim 31 where the line segment is parallel to the seat pan.

33. The seat recliner system of claim 32 where the line segment is parallel to the seat back.

34. The seat recliner system of claim 33 where the first seat holder is comprised of a first plurality of wheels and the second seat holder is comprised of a second plurality of wheels.
